(19) United States
(12) Patent Application Publication
(10) Pub. No.: US 2014/0324865 A1
(43) Pub. Date: Oct. 30, 2014

(54) METHOD, PROGRAM, AND SYSTEM FOR CLASSIFICATION OF SYSTEM LOG

(71) Applicant: INTERNATIONAL BUSINESS MACHINES CORPORATION, Armonk, NY (US)

(72) Inventor: Masayoshi Mizutani, Tokyo (JP)

(73) Assignee: INTERNATIONAL BUSINESS MACHINES CORPORATION, Armonk, NY (US)

(21) Appl. No.: 14/257,100

(22) Filed: Apr. 21, 2014

(30) Foreign Application Priority Data
Apr. 26, 2013 (JP) 2013-093930

(51) Int. Cl. G06F 17/30

(52) U.S. Cl. CPC G06F 17/30598; G06F 17/30327
USPC 707/737

(57) ABSTRACT

Method and system for classifying system logs. A data processing system reads a message in one line of a system log; prepares a root node of a tree structure in which each node holds a format; calculates a similarity between a log of the root node and the message; generates and stores a first format in the root node if the calculated similarity is equal to or greater than a threshold value; adds the message to a child node of the root node, in accordance with a given condition; searches for, after the first format is created, a second format similar to the first format in a format storage table; combines the first format and the similar format to produce a combined parent format, where the combined parent format holds a plurality of formats; and stores the combined parent format in the format storage table to produce a classified format.

### CROSS-REFERENCE TO RELATED APPLICATION

This application claims priority under 35 U.S.C. §119 from Japanese Patent Application No. 2013-093930 filed Apr. 26, 2013, the entire contents of which are incorporated herein by reference.

### BACKGROUND OF THE INVENTION

1. Field of the Invention

The present invention relates to techniques for classifying system logs generated by a computer system.

2. Description of Related Art

It is inevitable for computer systems to be hit by trouble and failure. These issues arise from various causes, such as hardware failure, failure of the local network, internet failure, software bugs, data corruption, and the like.

When such failure occurs, to be able to analyze the cause of the failure, means to generate system logs are taken at various levels, such as an operating system, middleware, an application program, and the like. Such system logs typically have the following features: an output message, in accordance with a format specified inside software or the like beforehand; one message is a sequence made up of symbols which include character(s); the message is not always readable by human beings, however, the message needs to be able to be disintegrated to a meaningful granularity; a readable character string is separated by spaces or special symbols.

At times when a system failure occurs, system logs with such above-mentioned features may be generated in large quantity. In such a case, in order to grasp the situation from these system logs and solve the problem quickly, it is necessary to identify the problem at a rapid speed.

As a technique to recognize the meaning of a character string generated, a natural language analytic approach, such as text mining or the like, is known. However, system logs are mechanically generated, therefore the natural language analytic approach cannot apply.

When the system logs generated are considered to be a data stream, as techniques for clustering data on the data stream, techniques described in Japanese Unexamined Patent Application Publication Nos. 2005-100363 and 2007-272892 are known.

In Japanese Unexamined Patent Application Publication 2005-100363, it is described that, firstly, online statistics are created by a data stream, then, offline processing of the online statistics is performed when offline processing is necessary or desired to be performed.

In Japanese Unexamined Patent Application Publication No. 2007-272892, a method for updating a probabilistic clustering system is described which is defined at least in part by a probabilistic model parameter which represents the number of words, the ratio, or the frequency which characterizes the class of a clustering system.

However, such above-mentioned techniques are not adapted to process a system log. In contrast, the following references describe techniques to process system logs: R. Vaarandi, “A breadth-first algorithm for mining frequent patterns from event logs,” in Proceedings of the 2004 IFIP International Conference on Intelligence in Communication Systems, 2004, pp. 293-308; A. A. Makanju, A. N. Zincir-Heywood, and E. E. Milios, “Clustering event logs using iterative partitioning,” in KDD '09: Proceedings of the 15th ACM SIGKDD international conference on Knowledge discovery and data mining. New York, N.Y., USA: ACM, 2009, pp. 1255-1264; L. Tang, T. Li, and C.-S. Perng, “Logsig: Generating system events from raw textual logs,” in Proceedings of ACM CIKM, 2011; and K. Q. Zhu, K. Fisher, and D. Walker, “Incremental learning of system log formats,” SIGOPS Oper. Syst. Rev., vol. 44, no. 1, pp. 85-90, March 2010., available: http://doi.acm.org/10.1145/1740390.1740410.

However, in the techniques described in the preceding paragraph, it is necessary to input certain hints beforehand and is assumed to run offline, therefore there are problems in that it is unsuitable to process logs that arrive sequentially, sufficient performance is not displayed when the data amount is small, and the like.

### SUMMARY OF THE INVENTION

One aspect of the present invention provides a computer-implemented method for inputting system logs and classifying formats. The method includes the steps of: reading a message in one line of a system log; preparing a root node of a tree structure in which each node holds a format; calculating a similarity between a log of the root node and the message; if the calculated similarity is equal to or greater than a threshold value, then i) generating a first format; and ii) storing the first format in the root node; adding the message to a child node of the root node, in accordance with a given condition; searching for, after the first format is created, a second format that is similar to the first format in a format storage table; combining the first format and the similar format to produce a combined parent format, if a similar format is found, wherein the combined parent format holds a plurality of formats; and storing the combined parent format in the format storage table to produce a classified format.

Another aspect of the present invention provides a computer readable non-transitory article of manufacture tangibly embodying computer readable instructions, which, when executed, cause a computer to perform the steps of the method above for inputting system logs and classifying formats.

Yet another aspect of the present invention provides a data processing system for inputting system logs and classifying formats. The data processing system includes a memory and a processing device communicatively coupled to the memory, where the processing device is configured to processing device is configured to: read a message in one line of a system log; prepare a root node of a tree structure, where each node of the tree structure holds a format; calculate a similarity between a log of the root node and the message; if the calculated similarity is equal to or greater than a given value, then i) create a first format; and ii) store the first format in the root node; replace the root node with a most similar child node if the similarity is less than a given threshold and a number of child nodes held by the root node is equal to or greater than a given number; add the message to the child node of the root node, if the similarity is lower than the given threshold and the number of child nodes held by the root node is less than the given number; search for, after the new format is created, a second format that is similar to the first format in a format storage table; if a similar format is found, combine the new format and the similar format to produce a combined parent format, where the combined parent formula holds a combination of a plurality of formats; and store the combined parent format in the format storage table to produce a classified format.

An object of the present invention is to provide a technique which is capable of performing online processing on logs that arrive sequentially.

Another object of the present invention is to provide a log processing technique which is effectively applicable even when the amount of log data is small.

The present invention solves the above-mentioned problems by defining one log message (single line in most systems) as one node and making a tree structure from log messages which are sequentially input, whilst searching for similar formats, creating new formats, and adjusting formats.

Throughout the present invention, a format is information which holds a combination of a fixed part and a variable part. For example, in the case where printf(“xxx % s yyy”,param); appears within a code of C language, amongst the format “xxx ppp yyy” that is output, xxx yyy is defined as the fixed part, and ppp is defined as the variable part.

The system of the present invention searches for a node from a tree structure with a newly input log message. On condition that a node holding a log message with a similarity equal to or higher than a given similarity is found for the newly input log message, a format is created, and is stored within the node.

Upon entering the adjustment phase, a format which is similar to the created format is searched for within a format table. On condition that similar format is found, the similarity between the created format and the found format is calculated. If the similarity is equal to or greater than a given value, a node of a parent format is created which combines the two formats. This means that the nodes of the two formats will hang from the created node of the parent format.

Returning to the search on the tree structure, according to a preferred aspect of the present invention, on condition that the similarity between the message of the current node and the log message which is newly input is smaller than or equal to the given similarity, the number of child nodes of the current node is examined. In a case where the number of child nodes is smaller than or equal to a given value, a child node holding the newly input log message is added. In a case where the number of child nodes has reached the given value, the most similar child node is substituted for the current node.

According to the present invention, the similarity between log messages is performed relatively strictly on tree structure. When n represents the number of log messages, the search time is on average 0(log n), and 0(n) at longest, thus taking relatively a short period. This time span to search will not increase dramatically even when n increases.

In contrast, the adjustment processing on a format, which relatively takes time, only takes place when the similarity between messages is higher than a given value, thus not reducing very much the overall performance.

As described above, a technique is provided which can perform online processing on logs.

### BRIEF DESCRIPTION OF THE DRAWINGS

FIG. 1 is a block diagram illustrating a hardware configuration for implementing the system configuration and process of the present invention.

FIG. 2 is a block diagram illustrating a functional configuration of the processing program of the present invention.

FIG. 3 is a diagram illustrating a flowchart detailing the processing operations of the present invention.

FIG. 4 is a block diagram illustrating an example of a tree structure used in a search phase.

FIG. 5 is a diagram illustrating a flowchart of a process for calculating the similarity between messages.

FIG. 6 is a diagram illustrating a flowchart of a process for creating a format.

FIG. 7 is a diagram illustrating an example of calculation of a similarity.

FIG. 8 is a diagram illustrating a flowchart of a process for searching for a similar format.

FIG. 9 is a diagram illustrating an example of a format search and registration process.

FIG. 10 is a diagram illustrating a flowchart of a process for creating a parent format.

FIG. 11 is a diagram illustrating a process for calculating the similarity between formats.

FIG. 12 is a diagram illustrating how a parent format is combined from two formats.

FIG. 13 is a diagram illustrating a relationship upon a tree structure, of two formats and a parent format.

### DETAILED DESCRIPTION OF THE PREFERRED EMBODIMENTS

Hereinafter, embodiments of the present invention will be described accordingly with the illustrations provided. The embodiments are presented to illustrate preferred aspects of the present invention. Therefore, it should be understood that it is not intended to limit the scope of the present invention. Furthermore, throughout the illustrations, unless otherwise indicated, the same reference signs are intended to refer to the same target.

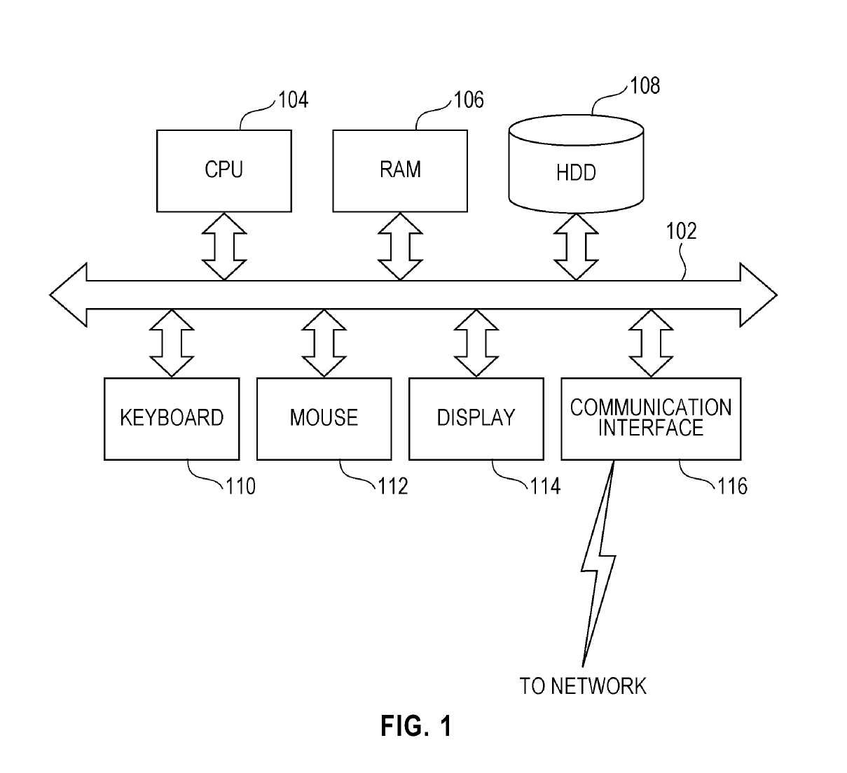

Referring to FIG. 1, a block diagram of computer hardware for implementing the system configuration and process is illustrated, according to an embodiment of the present invention. In FIG. 1, CPU 104, main memory, or random-access memory (RAM) 106, hard disk drive (HDD) 108, keyboard 110, mouse 112, and display 114 are connected to system bus 102. Preferably, CPU 104 is based on an architecture of 32 bits or 64 bits, and for example, can use Core™ i3, Core™ i5, Core™ i7, and Xeon® of Intel; and Athlon™, Phenom™, and Sempron™ of AMD, or the like. Preferably, RAM 106 has a capacity of 8 GB or more, and more preferably, has a capacity of 16 GB or more.

HDD 108 stores an operating system (OS). The operating system may be any which conforms to CPU 104, such as Linux™, Windows™ 7 or Windows™ 8 of Microsoft, or the like. Preferably, HDD 108 also stores a program to operate a system as a web server, such as Apache or the like. Furthermore, HDD 108 also holds a plurality of pieces of middleware and application programs.

Keyboard 110 and mouse 112 are used for operating graphic objects displayed on display 114 such as icons, task bars, text boxes, or the like, following the graphic user interface provided by the operating system.

Among the systems that operate on the hardware illustrated in FIG. 1, at least one of the operating system, the middleware, and the application program has an ability to generate a system log.

A system log, although not limited to the below, can be generated, for example, depending on the following system failures: hardware failure; communication-related failure such as local network failure, internet failure, or the like; bug on software; and partial or overall data corruption.

Such above-mentioned system logs typically have the following features: an output message, in accordance with a format specified inside software or the like beforehand; one message is a sequence made up of symbols which include character(s); the message is not always readable by human beings, however, and the message needs to be able to be disintegrated to a meaningful granularity; a readable character string separated by spaces or special symbols.

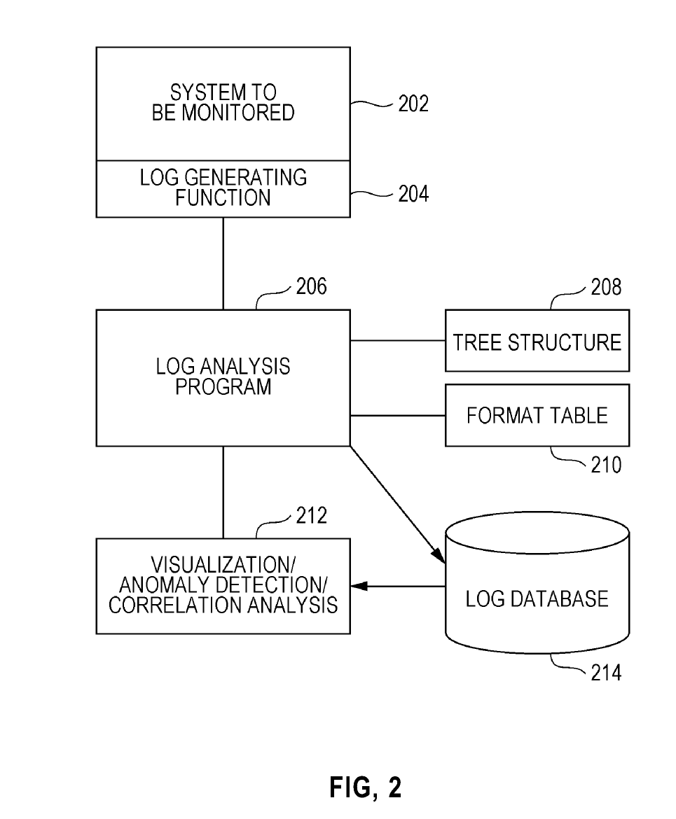

Moreover, HDD 108 further stores log analysis program 206 and visualization/anomaly detection/correlation analysis program 212, as illustrated in FIG. 2. Log analysis program 206 is executed by the operation of the operating system, loaded into RAM 106 from HDD 108. Log analysis program 206 and visualization/anomaly detection/correlation analysis program 212 can be created by any existing programming language processor such as C, C++, C#, Java®, or the like. Detailed functions of log analysis program 206 will be described later with reference to the functional block diagram of FIG. 2.

Next, with reference to the functional block diagram of FIG. 2, a configuration of a processing program of the present invention is explained. In FIG. 2, system to be monitored 202 is an operating system, middleware, an application program, or the like, and log generating function 204 detects a failure from system to be monitored 202 and generates a log message. Log generating function 204 can be a portion of the feature of the operating system or the middleware.

Log analysis program 206 receives the log message log generating function 204 generates, then studies, parses, and classifies the log message.

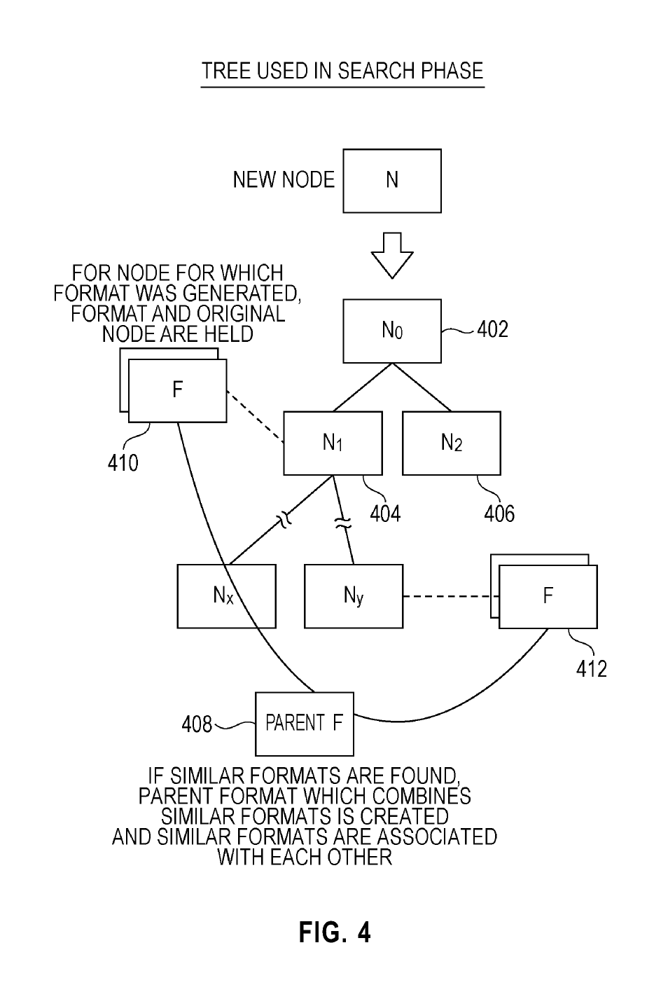

Log analysis program 206 has a message similarity calculation function, a format similarity calculation function, a format creating function, and a similar format search and registration function. Using these functions, log analysis program 206 creates tree structure data 208 as illustrated in FIG. 4 from log messages received, and calculates the similarity between a received log message and each of the messages of the nodes of the tree structure.

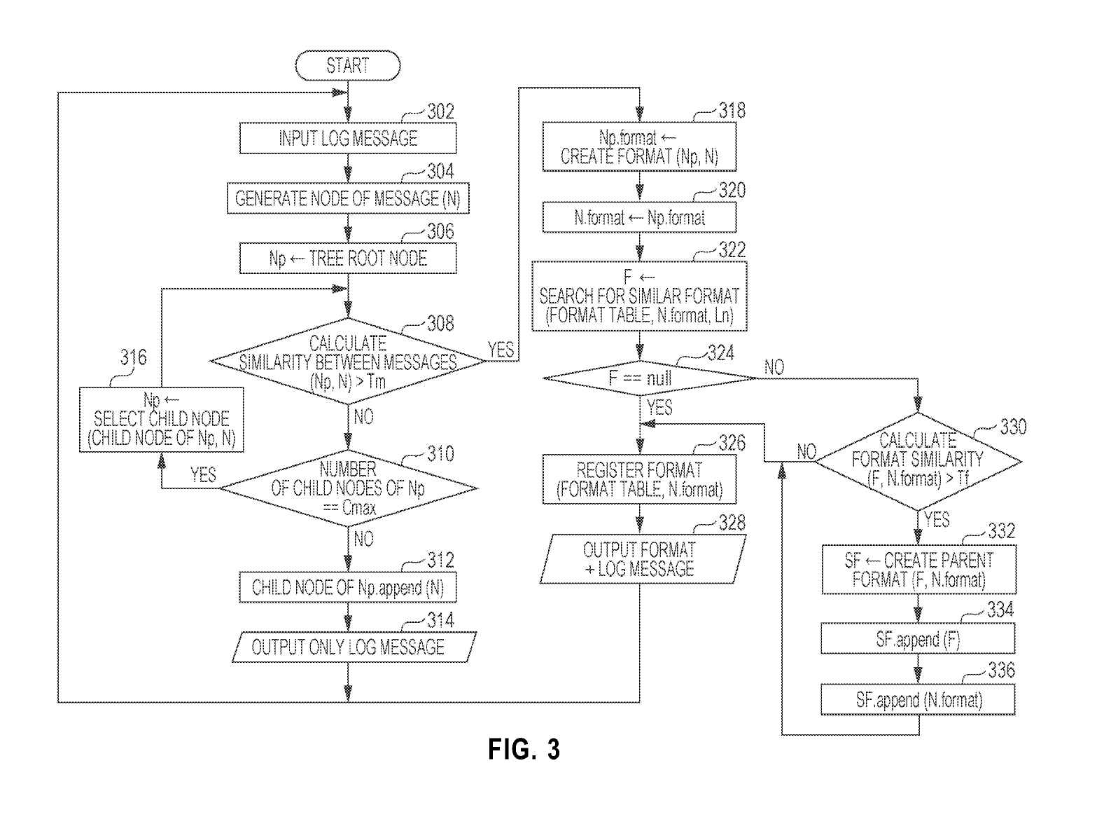

When the similarity is smaller than a given threshold, a new node is added. When the similarity is greater than the given threshold, the similarity is compared with a format stored in format table 210. When the similarity is greater than a given threshold, the formats are combined together, and a parent node is created. Log analysis program 206, if necessary, will write out a log message as log database 214 on HDD 108. The details of these processing operations will be described later on, with reference to the flowcharts of FIG. 3 and later figures.

Tree structure data 208 and format table 210 can be stored in RAM 106 or the HDD 108. However, at least for tree structure data 208, it is preferable as long as possible, to be stored in RAM 106, for faster processing.

Visualization/anomaly detection/correlation analysis program 212 receives an analysis output from log analysis program 206 and an entry from log database 214, visualizes the analysis output and the entry so as to be displayed to the user, detects anomaly by the comparison with a known anomaly log sample, and can also perform a correlation analysis with the known anomaly log sample. However, such a function does not hold much relevance to the features of the present invention, therefore it will not be described in further detail.

Next, with reference to the flowchart of FIG. 3, a description is given of the process of log analysis program 206. In FIG. 3, in step 302, log analysis program 206 inputs a log message of one line.

In step 304, log analysis program 206 converts the message into a node, that is, generates node N, and stores the message in N.message. Hereinafter, N.message is simply abbreviated as N.

In step 306, log analysis program 206 stores a tree root node in Np. The storing of tree root node 402 is indicated by an arrow in FIG. 4.

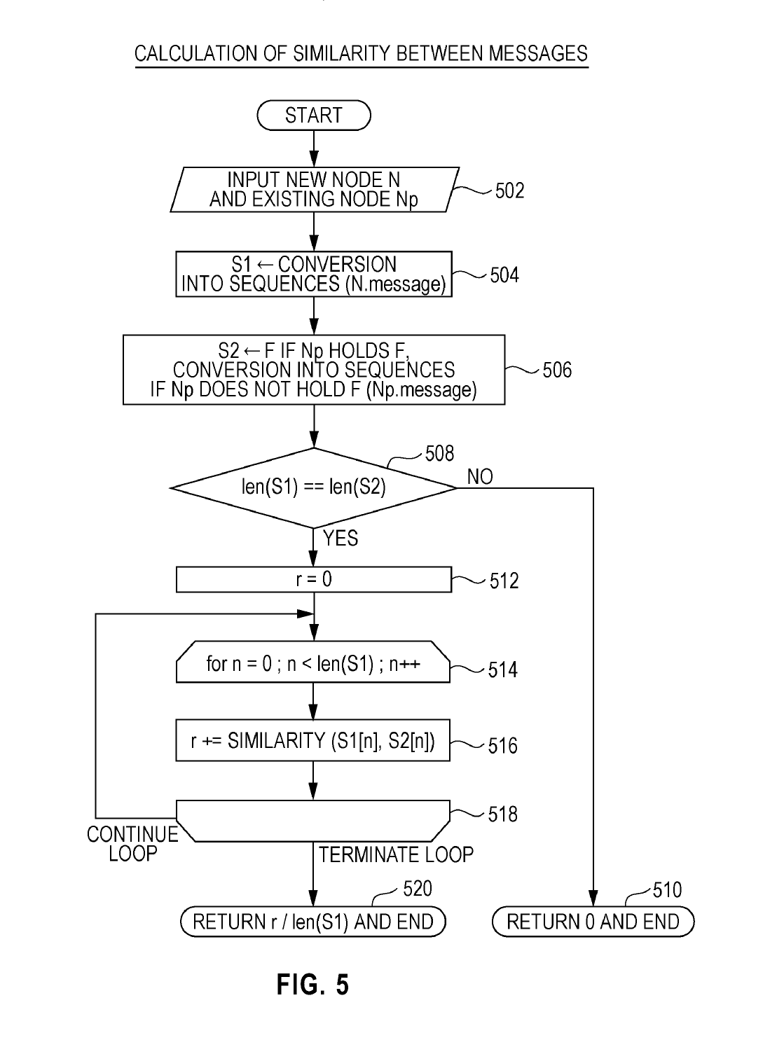

In step 308, log analysis program 206 calculates the similarity between N and Np. This calculation of the similarity will be explained later with reference to a flowchart of FIG. 5.

If it is determined that the similarity which is calculated in step 308 is not greater than a given threshold Tm, the process proceeds to step 310, and it is determined whether the number of child nodes of Np is equal to Cmax. Cmax is a given integer of 2 or more, however, empirically, it is chosen from a range between 4 and 10. For example, in FIG. 4, a node 404 and a node 406 are child nodes of the node 402.

If it is determined in step 310 that the number of child nodes of Np is not equal to Cmax, that is, the number of child nodes of Np is smaller than Cmax, log analysis program 206 adds, by append(N), N as a child node of Np, and in step 314, outputs only the log messages to visualization/anomaly detection/correlation analysis program 212 or log database 214. Then, the process returns to step 302.

If it is determined in step 310 that the number of child nodes is equal to Cmax, log analysis program 206 selects the child node that is most similar to N, and stores the message of the child node in Np in step 316. Then, the process returns to step 308. The determination of the similarities performed here may be based on the same algorithm as that used in step 308.

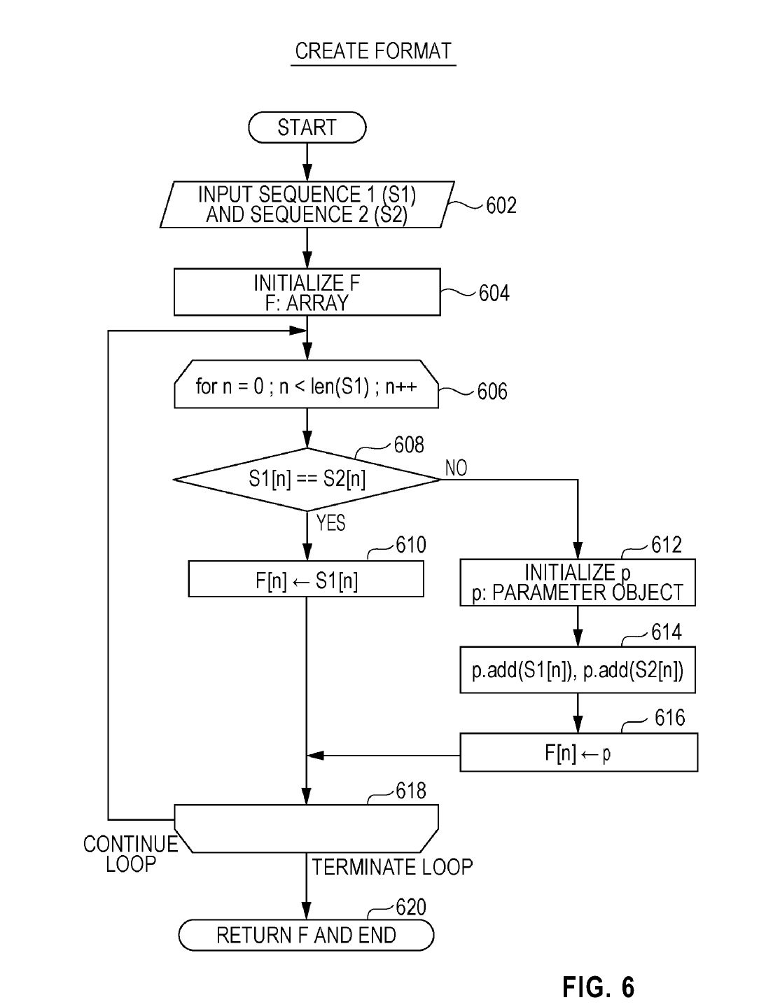

If, after returning to step 308, it is determined that the calculated similarity is equal to or greater than the given threshold Tm, log analysis program 206 generates a format from Np and N, and stores the generated format in Np.format in step 318. This process will be explained later with reference to a flowchart of FIG. 6.

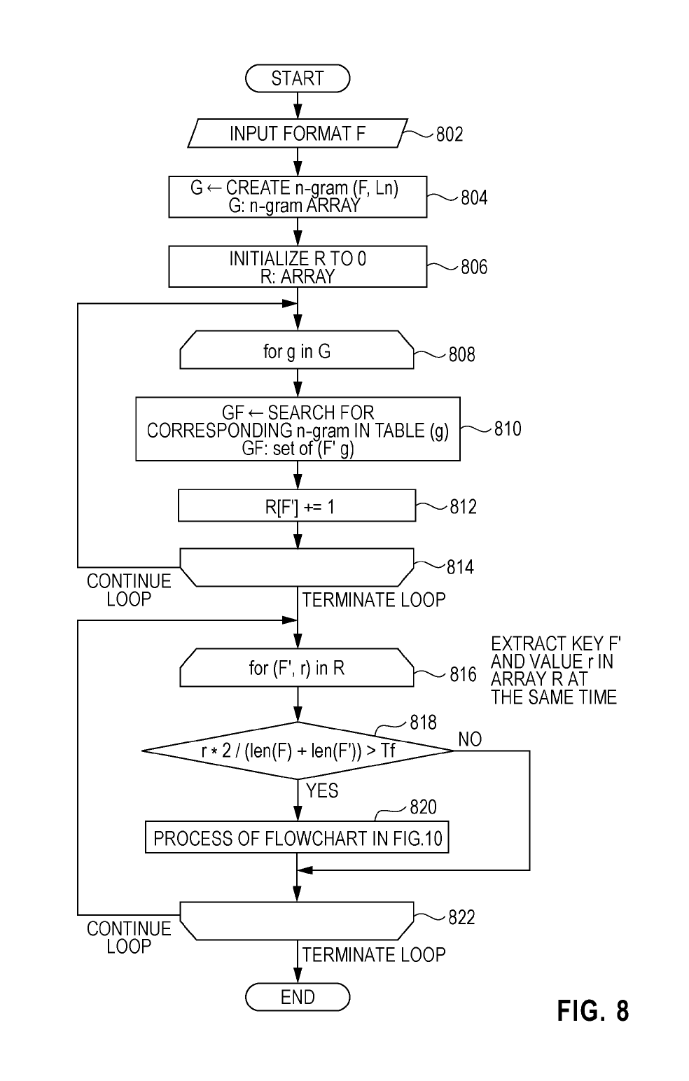

Following step 318, in step 320, the log analysis program 206 stores Np.format in N.format, and in step 322, searches for a format similar to N.format in the format table 210. When a similar format is found, the found format is labeled as F. Here, Ln indicates n-gram search. The search step for format table 210 is explained later with reference to a flowchart of FIG. 8.

In step 324, log analysis program 206 determines whether the search result of format table 210 is empty or not. In this embodiment, firstly, format table 210 is empty, therefore the determination made here is affirmative. Log analysis program 206 then registers N.format to format table 210 in step 326, and outputs the format plus log message to visualization/anomaly detection/correlation analysis program 212 or log database 214 in step 328. Then, the process returns to step 302.

If it is determined in step 324 that the search result of the format table 210 is not empty, the log analysis program 206 calculates the similarity between the formats of F and N.format in step 330. When the similarity is not greater than a given threshold Tf, the log analysis program 206 registers N.format on the format table 210 in step 326, and outputs the format+log message to the visualization/anomaly detection/correlation analysis program 212 or log database 214 in step 328. Then, the process returns to step 302. The process for calculating the similarity between formats will be explained later, with reference to the flowchart of FIG. 8.

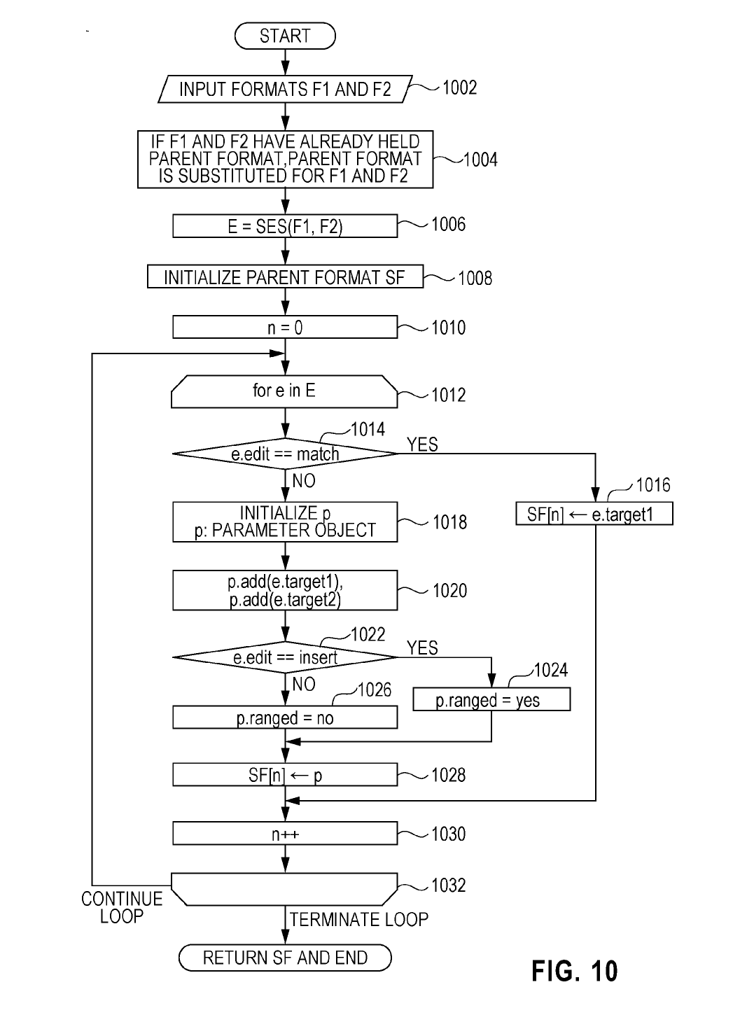

If it is determined in step 330 that the similarity between the formats of F and N.format is greater than Tf, the log analysis program 206 creates a parent format SF from F and N.format in step 330, adds F as a child node to the parent node SF in step 334, adds N.format as a child node to the parent node SF in step 336. Then, the process proceeds to step 326. The parent format creating process will be explained later with reference to a flowchart of FIG. 10. For example, in FIG. 4, it is illustrated that a node 408 holding a parent format has two nodes 410 and 412 added thereto.

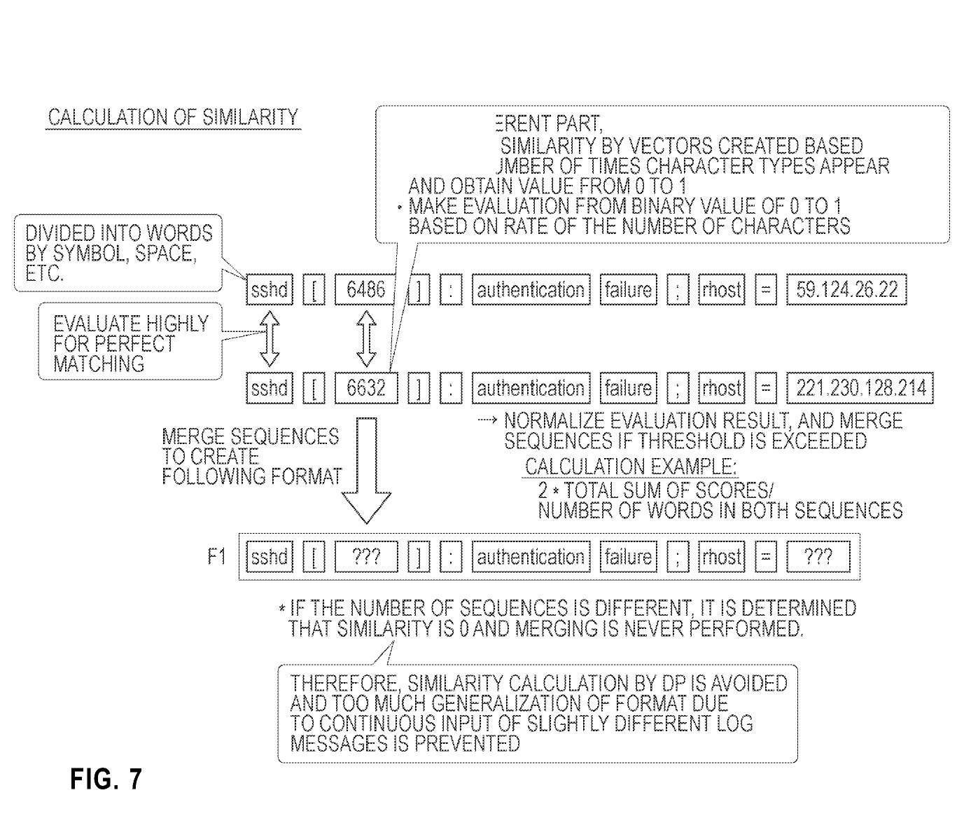

Next, a process for calculating the similarity between messages performed in step 308 of the flowchart of FIG. 3 is explained with reference to the flowchart of FIG. 5 and a schematic diagram of FIG. 7.

In step 502 of FIG. 5, log analysis program 206 inputs a new node N and an existing node Np.

In step 504, log analysis program 206 converts N.message into sequences, that is, as illustrated in FIG. 7, converts a message into a form divided into a plurality of sequences by spaces or symbols, such as sshd [6486]: authentication . . . , and substitutes the sequences into S1.

In step 506, if Np holds a format (F), log analysis program 206 substitutes the format into S2, or if Np does not hold a format (F), log analysis program 206 converts Np.message into sequences and substitutes the sequences into S2. Where a format is substituted into S2, in order to perform calculation of similarity, a message that has been formatted in Np.format is also converted into sequences.

In step 508, log analysis program 206 determines whether len(S1) is equal to len(S2). Here, len(S1) and len(S2) each represent the number of sequences.

If it is determined that len(S1) is not equal to len(S2), 0 is returned in step 510. Then, the routine of the function of calculating similarity between messages is terminated.

If it is determined in step 508 that len(S1) is equal to len(S2), the log analysis program 206 sets r to 0 in step 512. Then, the process proceeds to step 514.

According to the syntax of C language, the following condition is obtained in steps 514 to 518: for (n=0; n<len(S1); n++) {r+=similarity (S1[n],S2[n]);}, where S1[n] represents the n+1th sequence from the beginning when S1[0] represents the first sequence of S1.

Various calculation methods for the similarity (S1[n],S2[n]) may be available. The method described below is used in an embodiment.

```
      int s1[4],s2[4]; // declare array
      int L; // length of a character string
      char c;
      int i,t;
      s1[0] = s1[1] = s1[2] = s1[3] = 0; // initialize
      s2[0] = s2[1] = s2[2] = s2[3] = 0; // initialize
// calculation for S1[n]
for ( i = 0; i < ( L = strlen(S1[n])); i++ ) { //L represents the length
of S1[n]
      c = S1[n][i];
      if ( c >= ‘a’ && c <= ‘z’ ) s1[0]++;
      else if ( c >= ‘A’ && c <= ‘Z’ ) s1[1]++;
      else if ( c >= ‘0’ && c <= ‘9’ ) s1[2]++;
      else s1[3]++;
}
for ( i = 0; i < 4; i++ )
      s1[i] = s1[i]/L; // accordingly, 0 <= s1[i] <= 1
//calculation for S2[n]
for ( i = 0; i < ( L = strlen(S2[n])); i++ ) { //L represents the length
of S2[n]
      c = S2[n][i];
      if ( c >= ‘a’ && c <= ‘z’ ) s2[0]++;
      else if ( c >= ‘A’ && c <= ‘Z’ ) s2[1]++;
      else if ( c >= ‘0’ && c <= ‘9’ ) s2[2]++;
      else s2[3]++;
}
for ( i = 0; i < 4; i++ )
      s2[i] = s2[i]/L; // accordingly, 0 <= s2[i] <= 1
for ( i = 0, t = 0; i < 4; i++ )
      t += (s1[i] − s2[i])*(s1[i] − s2[i]);
                  // consequently, 0 <= t <= 4
r = sqrt((double) t); // consequently, 0 <= r <= 2
      When it is defined that the similarity (S1[n],S2[n]) returns r/2,
the following condition is obtained:
      0 <= similarity (S1[n],S2[n]) <= 1
```

In step 516, the similarity (S1[n],S2[n]) calculated as described above is accumulated to r.

In step 520, r/len(S1) is finally returned as a similarity.

Next, a format creating process will be explained with reference to the flowchart of FIG. 6.

In step 602 of FIG. 6, log analysis program 206 inputs S1 as a sequence 1, and inputs S2 as a sequence 2.

In step 604, log analysis program 206 prepares an initialized array F.

According to the syntax of C language, a loop for (n=0; n<len(S1); n++) { . . . } is obtained in the subsequent steps 606 to 618.

In step 608 within the loop, log analysis program 206 determines whether the condition S1[n]==S2[n] is satisfied. If this condition is satisfied, the sequences are equal to each other. Thus, in step 610, Si[n] is substituted for F[n].

If the condition S1[n]==S2[n] is not satisfied, log analysis program 206 initializes p, and defines p as a parameter object in step 612. In step 614, p.add(S1[n]) and p.add(S2[n]) are executed. Here, p represents the combination of all the sequences that have been input as parameters. In p.add(S1 [n]), S1[n] is added to p. In p.add(S2[n]), S2[n] is added to p.

In step 616, log analysis program 206 substitutes p into F[n]. As a result of the addition of sequences as described above, p becomes a long character string. According to the algorithm of character type calculation explained above relating to step 516 in FIG. 5, the similarity between character strings having different lengths can be obtained. The portion corresponding to p is called a variable part and is represented as “???” in FIG. 7, for the sake of convenience.

According to for (n=0; n<len(S1); n++), when steps 606 to 618 are completed for n, F is returned and the process is terminated in step 620. This processing corresponds to performing merging to generate F1 in FIG. 7.

Next, a similar format searching process in step 322 of FIG. 3 is explained with reference to FIG. 8.

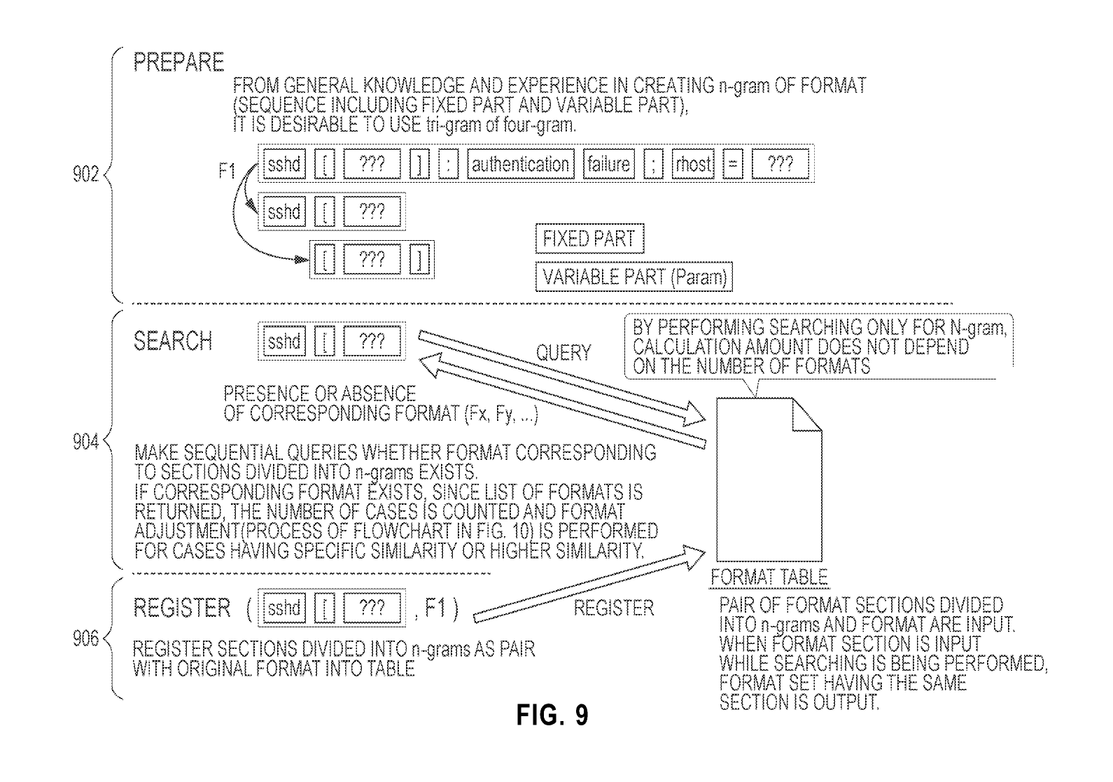

In step 802 of FIG. 8, log analysis program 206 inputs a format F. In step 804, log analysis program 206 creates n-gram from F, and stores the generated n-gram into G. That is, G represents an n-gram array or set of F. This corresponds to a portion represented by reference number 902 in FIG. 9.

In step 806, log analysis program 206 initializes an array R to 0.

Steps 808 to 814 are processing operations for each g, which is an element of G. In step 810, log analysis program 206 performs searching for g extracted from G in format table 210. When a format F′ including g is found, log analysis program 206 stores a pair (F′,g) into a set GF. This corresponds to a portion represented by reference numeral 904 in FIG. 9.

In step 812, log analysis program 206 adds 1 to R[F′]. That is, R includes an element (F′,r), and r is set to R[F′] here.

As described above, when processing for all g in G is completed and the loop of steps 808 to 814 is completed, log analysis program 206 proceeds to a loop of steps 816 to 822.

The loop of steps 816 to 822 is processing for each element (F′,r) of R.

In step 818, log analysis program 206 determines whether the condition r*2/(len(F)+len(F′))>Tf is satisfied. In this condition, Tf represents a given threshold. If the determination is negative, the process simply proceeds to the next element (F′,r). If the determination is affirmative, in order to create a parent format SF, the process of the flowchart in FIG. 10 is called. Then, the process proceeds to the next element (F′,r).

When the loop of steps 816 to 822 is completed as described above, the process is terminated. The portion represented by reference numeral 904 in FIG. 9 corresponds to step 330 of the flowchart in FIG. 3. Furthermore, the portion represented by reference numeral 906 in FIG. 9 corresponds to step 336 of the flowchart in FIG. 3.

Next, a process for creating a parent format SF will be explained with reference to the flowchart of FIG. 10.

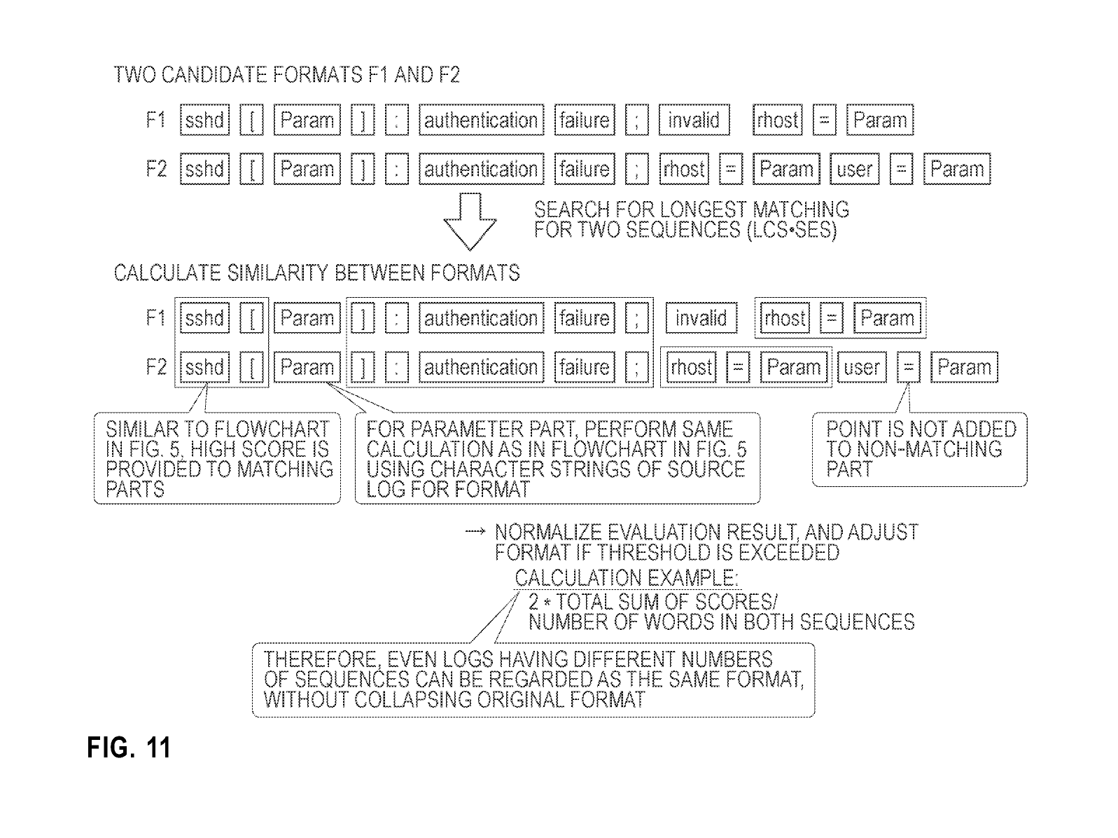

In step 1002 in FIG. 10, log analysis program 206 inputs formats F1 and F2. FIG. 11 illustrates an example of the formats F1 and F2.

In step 1004, if F1 and F2 have already held a parent format, log analysis program 206 replaces F1 and F2 with the parent format.

In step 1006, log analysis program 206 acquires longest matching E in such a manner that the condition E=SES(F1,F2) is satisfied. In this condition, SES stands for shortest edit script. Here, instead of SES, LCS, that is, longest common subsequence, may be used. More specifically, the condition E=SES(F1,F2) includes processing for calculating the similarity between formats, as illustrated in FIG. 11. Here, the similarity calculation process explained in association with the flowchart of FIG. 5 is performed.

Here, E represents a list of editing information e1, e2, . . . , and ei. As an operation for a sequence, e.edit includes either one of match, replace, or insert. Furthermore, e.target1 and e.target2 have targets F1[n1] and F2[n2], respectively, as attributes.

When e.edit is insert, either one of e.target1 or e.target2 is null. In addition, the condition len(E)<=max(len(F1),len(F2)) is satisfied.

Referring back to FIG. 10, in step 1008, log analysis program 206 initializes the parent format SF. In step 1010, n is set to 0.

Steps 1012 to 1032 form a loop for each element e of E.

In step 1014, log analysis program 206 determines whether e.edit is equal to match. If it is determined that e.edit is equal to match, e.target1 is substituted for SF[n] in step 1016, and n is incremented by one in step 1030. Then, the process proceeds to the next loop.

If it is determined in step 1014 that e.edit is not equal to match, log analysis program 206 initializes the parameter object p in step 1018, and executes p.add(e.target1) and p.add(e.target2) in step 1020. These processing operations are similar to the processing operations illustrated as steps 612 and 614 of the flowchart in FIG. 6. When t is null, p.add(t) is ignored. Here, since e.target1 and e.target2 each know to which p e.target1 and e.target2 belong. Thus, even if it is not determined to be a parameter from the original format, it can be determined to be a parameter by referring to a parent format.

In step 1022, log analysis program 206 determines whether e.edit is equal to insert. If it is determined that e.edit is equal to insert, log analysis program 206 sets p.ranged to yes in step 1024, substitutes p for SF[n] in step 1028, and increments n by one in step 1030. Then, the process proceeds to the next loop. At this time, setting p.ranged to yes represents a parameter of a variable length, thus being useful for analysis.

In step 1022, if log analysis program 206 determines that e.edit is not equal to insert, p.ranged is set to no in step 1024, p is substituted for SF[n] in step 1028, and n is incremented by one in step 1030. Then, the process proceeds to the next loop.

When steps 1012 to 1032 are completed for each element e of E as described above, log analysis program 206 returns SF. Then, the process illustrated in the flowchart of FIG. 10 is terminated.

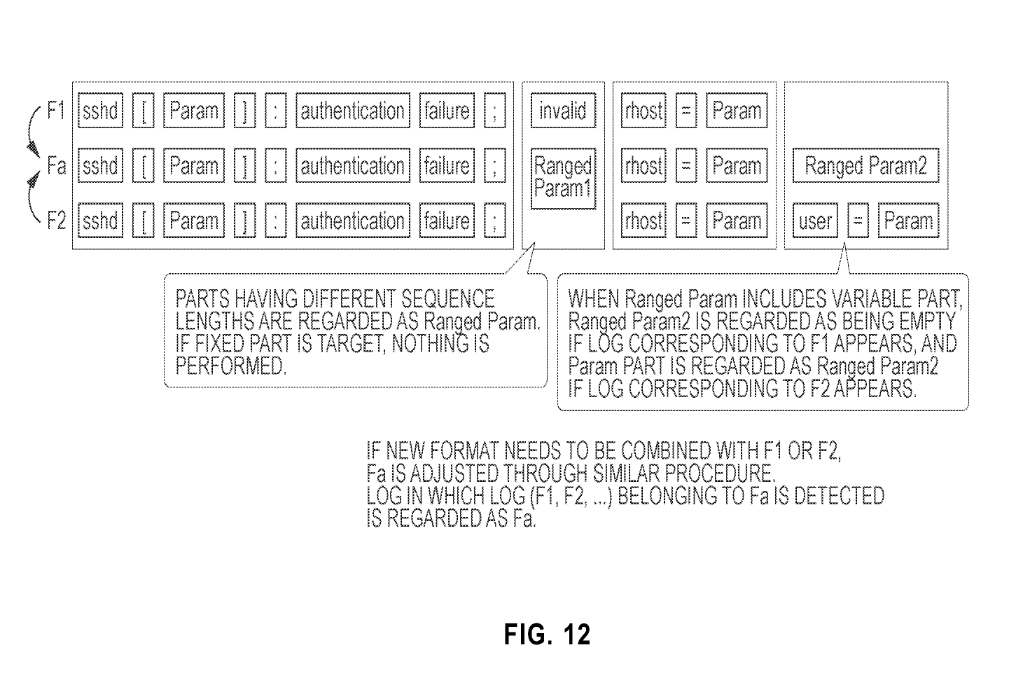

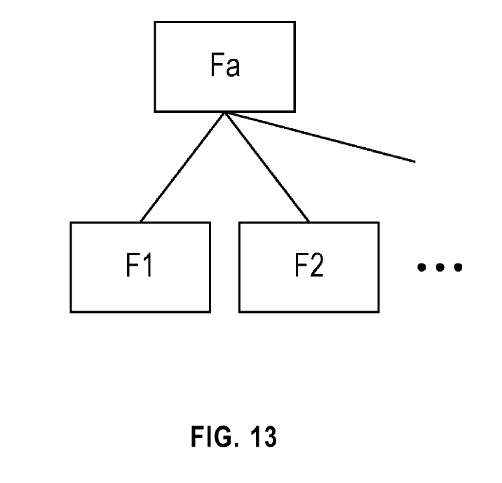

FIG. 12 illustrates an actual example of the process illustrated in FIG. 10. As illustrated in FIG. 12, Fa is generated from F1 and F2. The generated Fa corresponds to SF in the flowchart of FIG. 10. Consequently, as illustrated in FIG. 13, Fa serves as a parent format of both F1 and F2 on the tree structure.

For reference, an example of a log classification result generated by a system conforming to the present invention will be provided. In the logs provided below, * represents a variable part.

1 nsl sshd [*]: Connection closed by *
2 nsl sshd [*]: Generating*768 bit RSA key.
3 nsl xinetd [*]: START: * pid=* from=*
4 nsl sshd [*]: Did not receive identification string from *
5 nsl sshd [*]: fatal: Timeout before authentication for *
6 nsl sshd [*]: input_userauth_request: illegal user *
7 nsl sshd [*]: Failed password for * from * port * ssh2
8 nsl sshd [*]: Received disconnect from *: 11:Bye bye
9 nsl sshd [*]: Accepted password for test from * port *
10 nsl xinnetd [*]: EXIT:ftp pid=* duration=* (sec)

[symbol]

The present invention has been explained based on specific embodiments. However, it should be understood that the present invention is usable with any software/hardware configuration, without being limited to specific hardware, software, or platform.

Furthermore, the present invention is especially effective for online analysis of system logs. However, application of the present invention is not limited to this and may also be applicable to processing in batch. Furthermore, the maximum advantage of the present invention is achieved when failure has occurred. However, the present invention may also be used at a normal time for classifying logs output and estimating a format. Since there is enough margin to define a format of a log at a normal time, the advantage is not that maximized compared to the time when failure has occurred. However, labor-saving for one-time format definition and labor-saving for continuous maintenance can also be achieved.

We claim:

1. A computer-implemented method for inputting system logs and classifying formats, the method comprising the steps of:
reading a message in one line of a system log;
preparing a root node of a tree structure in which each node holds a format;
calculating a similarity between a log of the root node and the message;
if the calculated similarity is equal to or greater than a threshold value, then
i) generating a first format; and
ii) storing the first format in the root node;
adding the message to a child node of the root node, in accordance with a given condition;
searching for, after the first format is created, a second format that is similar to the first format in a format storage table;
if a similar format is found, then combining the first format and the similar format to produce a combined parent format, wherein the combined parent format holds a plurality of formats; and
storing the combined parent format in the format storage table to produce a classified format.

2. The method according to claim 1, wherein the step of adding the message to a child node of the root node further comprises:
replacing the root node with a most similar child node, if the calculated similarity is less than the threshold value and a number of child nodes held by the root node is equal to or greater than a given number; and
adding the message to the child node of the root node, if the calculated similarity is less than the threshold value and the number of child nodes held by the root node is less than the given number.

3. The method according to claim 1, wherein the step of calculating the similarity between messages further comprises:
dividing the messages into a plurality of sequences to produce divided sequences;
comparing the divided sequences;
adding a score to the divided sequences having a higher similarity; and
dividing a sum of scores by a total number of sequences.

4. The method according to claim 3, wherein if the divided sequences are different, the method includes the step of calculating the similarity between the divided sequences based on a vector of a number of times a character type appears.

5. The method according to claim 1, wherein during the step of searching in the format storage table, an n-gram search is performed.

6. The method according to claim 1, wherein during the combining the first format and the similar format to produce a combined parent format, formats of the plurality are divided into a plurality of editing elements in accordance with a shortest edit script, and each of the plurality of editing elements is processed.

7. A computer readable non-transitory article of manufacture tangibly embodying computer readable instructions, which, when executed, cause a computer to perform the steps of a method for inputting system logs and classifying formats, the method comprising the steps of:
reading a message in one line of a system log;
preparing a root node of a tree structure, wherein each node of the tree structure holds a format;
calculating a similarity between a log of the root node and the message;
if the calculated similarity is equal to or greater than a given threshold, then
i) generating a first format; and
ii) storing the first format in the root node;
adding the message to a child node of the root node, in accordance with a given condition;
searching for, after the first format is created, a second format that is similar to the first format in a format storage table;
if a similar format is found, then combining the first format and the similar format to produce a combined parent format, wherein the combined parent formula holds a combination of a plurality of formats; and
storing the combined parent format in the format storage table to produce a classified format.

8. The article of manufacture according to claim 7, wherein the step of adding the message to a child node of the root node further comprises:
replacing the root node with a most similar child node if the similarity is less than the given threshold and the number of child nodes held by the root node is equal to or greater than a given number; and
adding the message to the child node of the root node, if the similarity is less than the given value and the number of child nodes held by the root node is less than the given number.

9. The article of manufacture according to claim 7, wherein the step of calculating the similarity between messages further comprises:
dividing the messages into a plurality of sequences to produce divided sequences;
comparing at least two of the divided sequences;
adding a score to sequences having a higher similarity; and
dividing a sum of the scores by the number of sequences.

10. The article of manufacture according to claim 9, wherein if different sequences are compared with each other, then calculating the similarity between the sequences on the basis of a vector of a number of times a character type appears.

11. The article of manufacture according to claim 7, wherein during the step of performing searching in the format storage table, an n-gram search is performed.

12. The article of manufacture according to claim 7, wherein during the step of creating the combined parent format, formats are divided into a plurality of editing elements in accordance with a shortest edit script, and each of the plurality of editing elements are processed.

13. A data processing system for inputting system logs and classifying formats, the data processing system comprising a memory and a processing device communicatively coupled to the memory, wherein the processing device is configured to perform the steps of a method comprising:
reading a message in one line of a system log;
preparing a root node of a tree structure, wherein each node of the tree structure holds a format;
calculating a similarity between a log of the root node and the message,
if the calculated similarity is equal to or greater than a given value, then
i) creating a first format; and
ii) storing the first format in the root node;
replacing the root node with a most similar child node if the similarity is less than a given threshold and a number of child nodes held by the root node is equal to or greater than a given number;
adding the message to the child node of the root node, if the similarity is lower than the given threshold and the number of child nodes held by the root node is less than the given number;
searching for, after the new format is created, a second format that is similar to the first format in a format storage table;
if a similar format is found, then combining the new format and the similar format to produce a combined parent format, wherein the combined parent formula holds a combination of a plurality of formats; and
storing the combined parent format in the format storage table to produce a classified format.

14. The data processing system according to claim 13, wherein calculating the similarity between the messages further comprises:
dividing the messages into a plurality of sequences to produce divided sequences;
comparing the divided sequences;
adding a score to sequences having a higher similarity; and
dividing a sum of the scores by a number of sequences.

15. The data processing system according to claim 14, wherein the processing device is further configured to:
calculate a similarity between the sequences using a vector based on a number of times a character type appears, if different sequences are compared with each other.

16. The data processing system according to claim 13, wherein during the searching in the format storage table, an n-gram search is performed.

17. The data processing system according to claim 13, wherein the processing device, during the step of combining the new format and the similar format, is further configured to:
divide formats into a plurality of editing elements in accordance with a shortest edit script; and
process each of the plurality of editing elements.
